(19) United States
(12) Patent Application Publication
(10) Pub. No.: US 2006/0228260 A1
(43) Pub. Date: Oct. 12, 2006

(54) Optical analysis device

(75) Inventor: Satoru Nishiuma, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/553,870

(22) PCT Filed: Dec. 9, 2004
(86) PCT No.: PCT/JP04/18772

§ 371 Date: Oct. 21, 2005

(30) Foreign Application Priority Data
Dec. 16, 2003 (JP) 2003-418173

(51) Int. Cl. G01N 21/00

(52) U.S. Cl. 422/82.11

(57) ABSTRACT

An optical analysis device comprises a lighttransmitting member for transmitting light, having an external face capable of immobilizing a detectionobjective substance, a light separating means for separating an exciting light introduced into the light-transmitting member at a first end thereof and transmitted through the light-transmitting member, and a fluorescence light produced by excitation of the detection-objective substance by the exciting light, at a second end of the light-transmitting member, and a detecting means for detecting the fluorescence light separated by the light separating means.

### TECHNICAL FIELD

The present invention relates to an optical analysis device for chemical or biochemical analysis by an optical method, particularly to an optical analysis device for chemical or biochemical analysis by an evanescent wave.

### BACKGROUND ART

The blood contains plural kinds of markers for specific diseases such as cancer and hepatitis. Contraction of the disease increases the concentration of the specific protein in the blood from that in a healthy state. Monitoring of the specific protein concentration in the blood in a healthy state is promising as a next-generation medical technique since it enables early detection of serious diseases. One method for detection of untreated unrefined protein is based on a sensor capable of identifying the specific compound by a biological ligand-receptor interaction. Some of such methods employ a sensor utilizing an evanescent wave of an optical fiber, a sensor utilizing surface plasmon resonance, or the like.

The sensor utilizing an evanescent wave of an optical fiber is based on an evanescent wave (electric field) effect. The evanescent (electric field) effect is a phenomenon that an electromagnetic wave passing through a substance and reflected at a dielectric interface generates, in a second substance outside the interface, an electric field which attenuates exponentially. Although the region of the evanescent wave formation, namely the depth of penetration of the wave into the second substance, is only a fraction of the wavelength, the size of the region is larger than an optical labeling substance such as a reporter molecule generating light or fluorescence light, a light-absorbing or -scattering molecule, a colloid particle, and a microsphere. Such an optical labeling substance is useful for producing or monitoring an optical change in the evanescent wave region, or for changing light propagation in the adjacent dielectric material; and useful for detecting a target substance near the surface.

Sensors utilizing an evanescent wave of an optical fiber are disclosed in U.S. Pat. No. 4,447,546, Japanese Patent Application Laid-Open No. 2002-257732, and so forth.

In the evanescent-wave sensor described in the above disclosure, a labeled antigen-antibody complex is immobilized on a side wall of an optical fiber having a reflecting face at one fiber end; exciting light is introduced through the other end of the optical fiber; the label of the antigen-antibody complex immobilized on the side wall of the optical fiber is excited by the evanescent wave of the exciting light introduced into the optical fiber to produce fluorescence; a part of the produced fluorescence penetrates into the optical fiber and returns to the optical system together with the reflected exciting light; and the fluorescence light is detected by an optical sensor.

However, with the sensors described in U.S. Pat. No. 4,447,546 and Japanese Patent Application Laid-Open No. 2002-257732, the fluorescence light emitted from the antigen-antibody and the exciting light reflected by the optical fiber end face are led out together from the other end of optical fiber. The fluorescence light and the exciting light led out together from the end of the optical fiber should be separated for measurement of the fluorescence light. In the above disclosures, the separation is conducted by use of a filter which intercepts the exciting light and transmits the fluorescence light. However, the manufacture of such a filter is practically extremely difficult which intercepts the exciting light by 100% and transmits the fluorescence light by 100%.

The exciting light, which has generally an intensity higher than that of the fluorescence light, is detected as a stronger background noise by the optical sensor. Therefore, in the above disclosed methods, the fluorescence light is detected by a small change on the strong background. In order to detect the fluorescence light with high sensitivity, the source of the exciting light causing the background should be extremely stabilized.

Further, with a conventional technique, for introducing the exciting light into an optical waveguide from the fiber end face, a point light source should be prepared to have a diameter of one-fourth or less of the optical fiber diameter. For strict registration, the light source and the optical waveguide should be integrated. For measurement of many specimens, many light sources should be provided.

### DISCLOSURE OF THE INVENTION

According to an aspect of the present invention, there is provided an optical analysis device comprising:
a light-transmitting member for transmitting light, having an external face capable of immobilizing a detection-objective substance;
a light separating means for separating an exciting light introduced into the light-transmitting member at a first end thereof and transmitted through the light-transmitting member, and a fluorescence light produced by excitation of the detection-objective substance by the exciting light, at a second end of the light-transmitting member, and
a detecting means for detecting the fluorescence light separated by the light separating means.

The light-separating means is preferably a diffraction grating.

The light-transmitting member preferably comprises an optical waveguide.

The optical analysis device preferably comprises a flow path which covers the light-transmitting member and has an inlet for introducing the detection-objective substance and an outlet for discharging the detection-objective substance.

The light-transmitting member preferably has at the first end thereof a coupling means for coupling the exciting light to the light-transmitting member. The coupling means is preferably a diffraction grating.

The external face of the light-transmitting member is preferably capable of immobilizing a trapping component for trapping the detection-objective substance. The trapping component preferably traps the detection-objective substance by an antigen-antibody reaction. Alternatively, the trapping component preferably traps the detection-objective substance by hybridization reaction of DNA.

According to the present invention, exciting light is introduced efficiently from a simple light source into a waveguide. Further according to the present invention, the exciting light for exciting a fluorescent substance and the fluorescence light emitted from the fluorescent substance are perfectly separated form each other, whereby a fluorescence immune sensor of a higher sensitivity can be provided.

### BRIEF DESCRIPTION OF THE DRAWINGS

FIGS. 1A and 1B illustrate schematically First Embodiment of the present invention.

FIGS. 2A and 2B illustrate schematically Second Embodiment of the present invention.

FIGS. 3A and 3B illustrate schematically Third Embodiment of the present invention.

FIGS. 4A and 4B illustrate schematically Fourth Embodiment of the present invention.

### BEST MODE FOR CARRYING OUT THE INVENTION

The present invention provides an optical analysis device in which an optical waveguide for light transmission is provided so as to pierce a flow path of a liquid, exciting light is introduced into the optical waveguide from one end thereof and is transmitted to excite a detection-objective substance immobilized on the external side wall, the exciting light and the fluorescence light emitted from the excited detection-objective substance are outputted together from the other end of the optical waveguide, the fluorescence light is separated from the exciting light, and the intensity of the separated fluorescence light is measured to determine the concentration of the detection-objective substance.

Four embodiments of the present invention are described by reference to drawings. The specific embodiments are described in detail for complete understanding of the present invention without limiting the invention to the description.

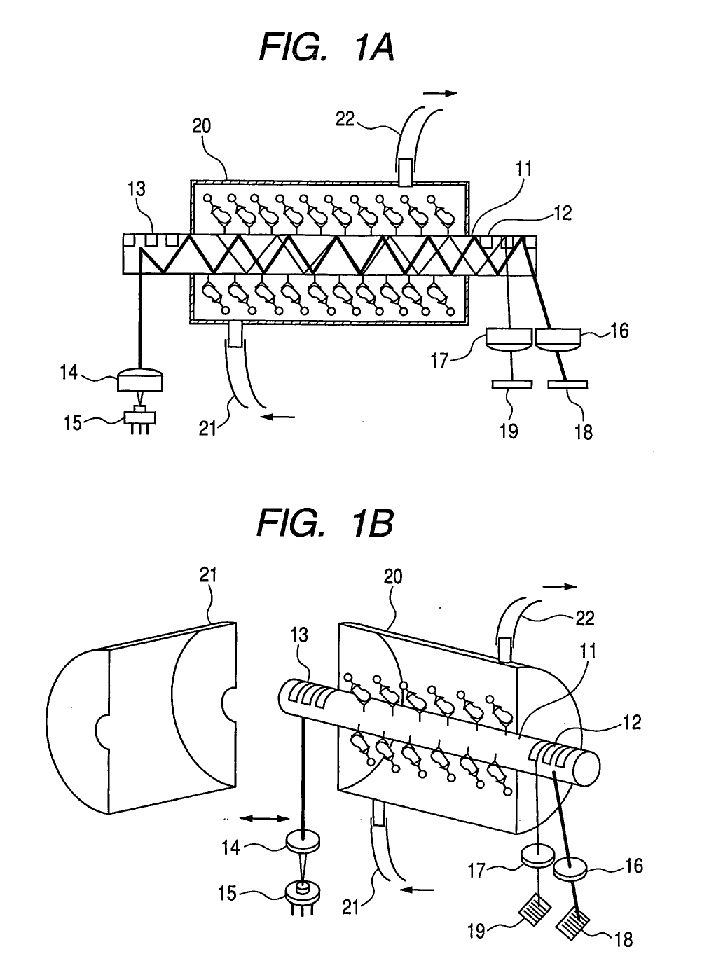

A first embodiment of the present invention is explained by reference to FIGS. 1A and 1B.

Columnar optical waveguide 11 is placed in a sealed flow path 20. Diffraction gratings 12,13 are provided at the end portions of columnar optical waveguide 11 protruding from the flow path 20. Exciting light emitted from light source 15 is converted to a parallel ray by collimator lens 14. The parallelized light is coupled through diffraction grating 13 under total reflection condition to one end of columnar optical waveguide 11, and is introduced therein. The introduced exciting light propagates through the optical waveguide by internal total reflection by the peripheral wall face of columnar optical waveguide 11. The exciting light having reached the other end of columnar optical waveguide 11 is separated into light components by diffraction grating 12 provided at the other end and is led out of columnar optical waveguide 11. The exciting light led out is condensed by condenser lens 16 and is detected by optical sensor 18.

A fluorescent dye attached to a detection object contained in a specimen and immobilized on the external wall of columnar optical waveguide 11 is excited by evanescent light which is induced by the exciting light introduced into the columnar optical waveguide 11 under total reflection condition to emit fluorescence light. A part of this fluorescence light penetrates into columnar optical waveguide 11, propagates therein, and is separated by diffraction grating 12 provided at the other end of the optical waveguide. The separated fluorescence light is led out of the columnar waveguide 11, condensed by condenser lens 17, and detected by optical sensor 19.

Columnar optical waveguide 11 is preferably an optical fiber made of a material which causes little transmission loss of the exciting light. The material includes polystyrene (PS), polymethyl methacrylate (PMMA), and polycarbonate (PC). Diffraction gratings 12,13 may be a Bragg diffraction grating, a blazed diffraction grating, a holographic diffraction grating. In this Embodiment, a Bragg diffraction grating is preferred. The Bragg diffraction grating is a diffraction grating of a transmission type; the holographic diffraction and the blazed diffraction grating are of a reflection type.

Collimator lens 14 may be a plano-convex lens, a SELFOC lens, an aspherical lens, or a double-convex lens. In the constitution of this Embodiment, a plano-convex lens, a SELFOC lens, and an aspherical lens are preferred. The double-convex lens is excluded from the preferred lenses since the double-convex lens is not suitable for parallelizing (collimating) the light and requires some modification for the parallelization.

Light source 15 may be a laser diode or gas laser which emits light of a wavelength ranging from 200 nm to 1000 nm. In this Embodiment, the wavelength is preferably not more than 670 nm.

Condenser lenses 16, 17 may be selected from a group of lenses including plano-convex cylindrical lenses, plano-concave cylindrical lenses, aspherical lenses, plano-convex lenses, and double-convex lenses; microscope objective lenses; and SELFC lenses. In the constitution of this Embodiment, a plano-convex lens, a plano-concave lens, and an aspherical lens are preferred. The plano-convex lens and the double-convex lens are not preferred since these lenses should be constructed into a complicated lens group assembly. The SELFOC lens is not preferred since it can cause a large loss to result in low sensitivity in this constitution.

Optical sensors 18, 19 may be a photodiode, or a photomultiplier. In the constitution of this Embodiment, the photodiode or the photomultiplier is suitably selected depending on the concentration of the objective substance in the specimen.

Flow path 20 may be a cylindrical capillary, or a tube. The cylindrical capillary is preferred in this Embodiment.

Inlet 21 and outlet 22 may preferably be formed respectively by boring the flow path 20 to form an open hole, inserting a pipe, and connecting a tube thereto. In the drawings for explaining the embodiments, one inlet and one outlet are formed. Naturally, the inlet, the outlet, or both may be formed in plurality.

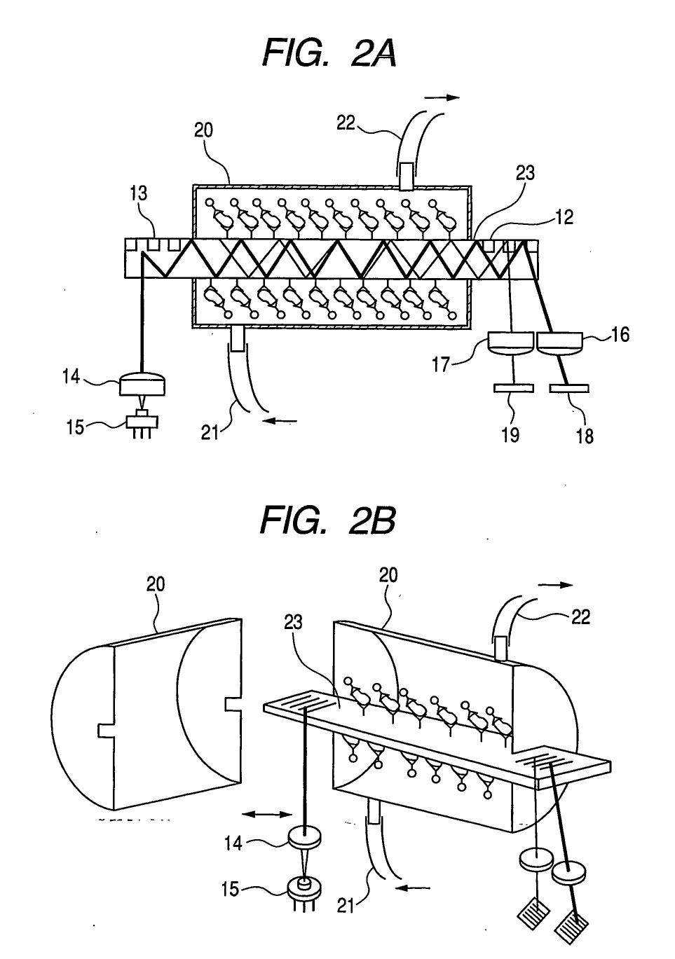

Second Embodiment of the present invention is explained below by reference to FIGS. 2A and 2B. In FIGS. 2A and 2B, the same symbols are used to denote the same elements as in First Embodiment. However, a different symbol is used to denote the corresponding constitutional element having a different shape or made from a different material.

This Second Embodiment is different from First Embodiment in that a planar optical waveguide 23 is used in place of columnar optical waveguide 11.

Similarly as in First Embodiment, exciting light emitted from light source 15 is converted to a parallel ray by collimator lens 14, coupled under total diffraction condition to one end of planar optical waveguide 23, and introduced into planar optical waveguide 23. The introduced exciting light propagates through optical waveguide 23 by total reflection on the wall face of planar optical waveguide 23. The exciting light having reached the other end of planar optical waveguide 23 is separated into light components by diffraction grating 12 provided at the end, and is led out of planar optical waveguide 23. The exciting light led out is condensed by condenser lens 16 and is detected by optical sensor 18.

A fluorescent dye attached to a detection object contained in a specimen and immobilized on the external wall of planar optical waveguide 23 is excited by evanescent light which is induced by the exciting light introduced into the planar optical waveguide 23 under total reflection condition to emit fluorescence light. A part of this fluorescence light penetrates into planar optical waveguide 23, propagates therein, and is separated into light components by diffraction grating 12 provided at the other end of the optical waveguide. The separated fluorescence light is led out of the planar waveguide 23, condensed by condenser lens 17, and detected by optical sensor 19.

Planar optical waveguide 23 is preferably made of a material which causes less transmission loss of the exciting light. The material includes polystyrene (PS), polymethyl methacrylate (PMMA), and polycarbonate (PC).

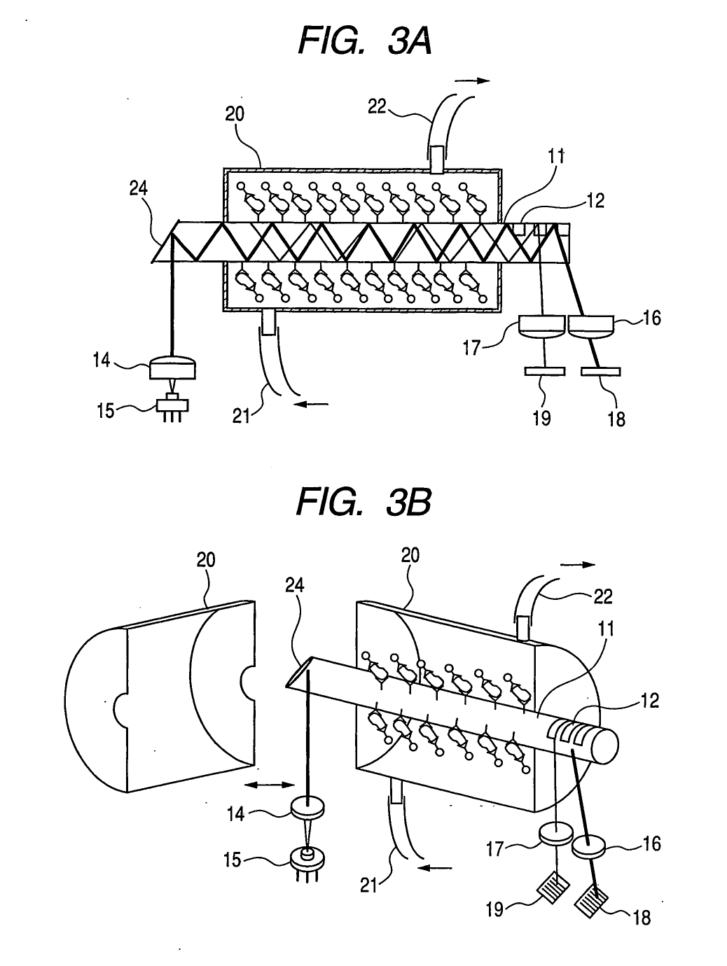

Third Embodiment of the present invention is explained below by reference to FIGS. 3A and 3B. In FIGS. 3A and 3B, the same symbols are used to denote the same elements as in First Embodiment. However, a different symbol is used to denote the corresponding constitutional element having a different shape or made from a different material.

Third embodiment is different from First Embodiment in that, in place of diffraction grating 13, mirror 24 is provided which is formed by cutting columnar optical waveguide 11 at an angle to cause total reflection of the light from light source 15 at the end of columnar optical waveguide 11 where the exciting light is introduced.

Exciting light emitted from light source 15 is converted to a parallel ray by collimator lens 14, coupled under total diffraction condition to mirror 24 provided at one end of columnar optical waveguide 11, and is introduced into columnar optical waveguide 11. The introduced exciting light propagates through the optical waveguide by total reflection at the wall face of columnar optical waveguide 11. The exciting light having reached the other end of columnar optical waveguide 11 is separated into light components by diffraction grating 12, and is led out of columnar optical waveguide 11. The exciting light led out is condensed by condenser lens 16 and is detected by optical sensor 18.

A fluorescent dye attached to a detection object contained in a specimen immobilized on the external wall of columnar optical waveguide 11 is excited by evanescent light which is induced by the exciting light introduced into the columnar optical waveguide 11 under total reflection condition to emit fluorescence light. A part of this fluorescence light penetrates into columnar optical waveguide 11, propagates therein, and is separated into light components by diffraction grating 12 provided at the other end of the optical waveguide. The separated fluorescence light is led out of the columnar waveguide 11. The fluorescence light led out is condensed by condenser lens 17 and is detected by optical sensor 19.

Mirror 24 is a total reflection mirror formed by cutting columnar waveguide 11 at an angle of 10° to 50° relative to the light transmission direction and polishing the cut end face, a mirror formed by vapor deposition of a metal film on the polished cut end face, a mirror laminated on the polished cut face, or combination thereof. In this Embodiment, the mirror is preferably formed by vapor-deposition of Al, Ag, Au, or Cr on the polished face.

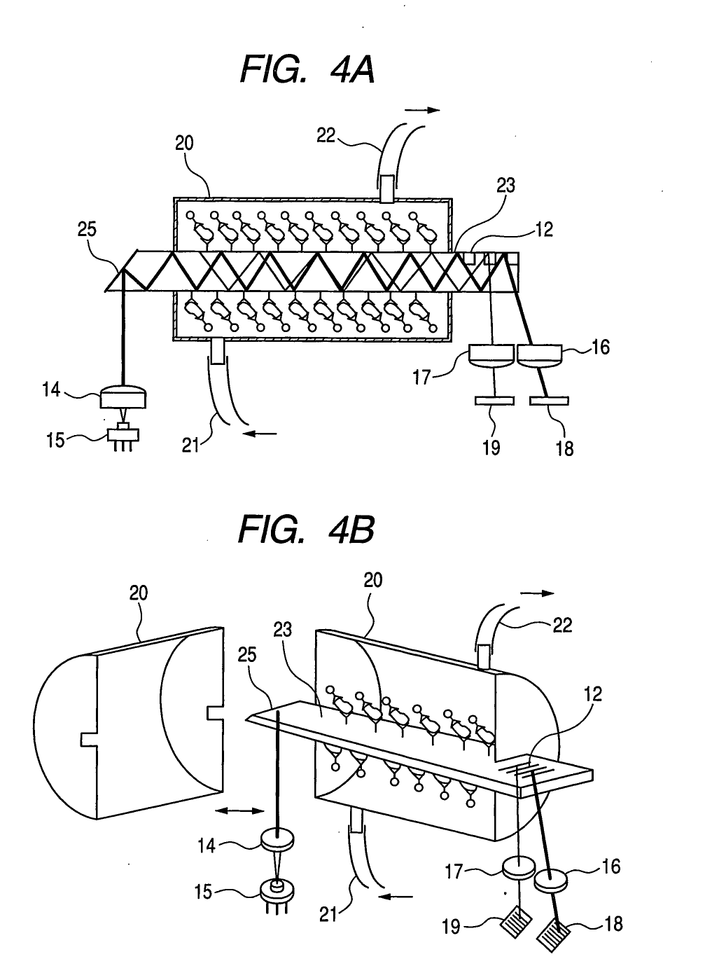

Fourth Embodiment of the present invention is explained below by reference to FIGS. 4A and 4B. In FIGS. 4A and 4B, the same symbols are used to denote the same elements as in First Embodiment. However, a different symbol is used to denote the corresponding constitutional element having a different shape or made from a different material.

This Fourth Embodiment is different from Third Embodiment in that a planar optical waveguide 23 is employed in place of columnar optical waveguide 11. Mirror 25 is formed, similarly as in columnar waveguide 11 of Third Embodiment, at the end face of planar optical waveguide 23 on which the exciting light is introduced.

Exciting light emitted from light source 15 is converted to a parallel ray by collimator lens 14, coupled under total diffraction condition to mirror provided at one end of planar optical waveguide 23, and introduced into planar optical waveguide 23. The introduced exciting light propagates through the planar optical waveguide 23 by total reflection on the wall face of planar optical waveguide 23.

The mirror may be a total reflection mirror formed by cutting columnar waveguide at an angle of 10° to 50° relative to the plane of planar optical waveguide and polishing the cut end face, a mirror formed by vapor deposition of a metal film on the polished cut end face, a mirror laminated on the polished cut face, or combination thereof. The exciting light having reached the other end of planar optical waveguide 23 is separated into light components provided at the end of planar optical waveguide 23 and is led out of planar optical waveguide 23. The exciting light led out is condensed by condenser lens 16 and is detected by optical sensor 18.

A fluorescent dye of a detection object immobilized from the specimen on the external wall of planar optical waveguide 23 is excited by evanescent light of the exciting light introduced into the planar optical waveguide 23 to emit fluorescence light. A part of this fluorescence light penetrates into planar optical waveguide 23, propagates therein, and is separated into light components by diffraction grating 12 provided at the other end of optical waveguide 23. The separated fluorescence light is led out of the planar waveguide 23. The fluorescence light led out is condensed by condenser lens 17 and is detected by optical sensor 19.

Planar optical waveguide 23 may be made of polystyrene (PS), polymethyl methacrylate (PMMA), or polycarbonate (PC). In this constitution, PS, PMMA, or PC is preferably used.

In the above First to Fourth Embodiment of the present invention, the exciting light introduced into the optical waveguide does not return to the light-introducing face. Thereby, the fluctuation of the output of the light-emitting source caused by the return of the exciting light is prevented, thus the problem of the present invention being solved. The output through the diffraction grating provided at the output end will prevent reflection of the exciting light at the output end face, being different from direct output at the end. Further, in addition to the provision of the diffraction grating at the output end, the output end face is preferably made light-absorbent to prevent the reflection by the output end face.

The light input end and the light output end respectively protrude out of the flow path. The light is introduced and led out from the sides. Therefore, the diameter of the light beam and light introduction position need not be strictly adjusted as in conventional technique. This enables mass production of optical analysis device tips having combination of a flow path and an optical waveguide, and analysis by setting the optical analysis device tip onto an analysis device having a light source and a detection assembly.

### EXAMPLE

Examples of the present invention are described below without limiting the invention to the description.

### Example 1

Explanation is made by reference to FIGS. 1A and 1B. Columnar optical waveguide 11 was a bar made of PS of about 1 mm diameter and 40 mm long, having diffraction grating 12 for light introduction at one end and diffraction grating 13 for light separation at the other end. Collimator lens 14 was a plano-convex lens (Sigma Koki K.K., 5 mm diameter). Light source 15 was a laser diode (Sanyo Electric Co., DL3038-033). Condenser lenses 16,17 were respectively a plano-convex lens (Sigma Koki K.K., 10 mm diameter). Optical sensors 18,19 were respectively a photodiode (Hamamatsu Photonics K.K., S2833-01, plano-convex cylinder lens). Flow path 20 was made of a black plastic resin.

The optical waveguide was immersed in a 1×10⁻⁷ mol/L solution of Cy5 (fluorescent dye, produced by Amersham Biosciences Co. (USA)). The treated optical waveguide was set in a completed optical system. Upon introduction of a laser light beam (wavelength: about 638 nm, effective intensity: 3 mW, modulated by rectangular wave of 135 Hz) from the laser diode, the fluorescent dye on the surface of the optical waveguide was excited by an evanescent light to emit fluorescence light. The exciting light and the fluorescence light were separated from each other by the diffraction grating. The fluorescence light could be detected with a high sensitivity.

Next, detection was conducted of PSA, a known prostate cancer marker. Firstly, streptoavidin was immobilized on the external face of the optical waveguide. Then a biotin-modified PSA antibody was adsorbed thereon. Thus prepared immunity sensor was set on a fluorescence analysis device. Then the protocol below was practiced:
(1) An antibody labeled with Cy5 dye for fluorescence is introduced into the flow path, and incubation is conducted for five minutes;
(2) The labeled antibody is removed from the flow path, and the flow path is washed with a phosphate buffer solution;
(3) A solution contaminated with an antigenic protein is introduced into the flow path, and incubation is conducted for five minutes;
(4) The solution containing the antigen is removed, and the flow path is washed with a phosphate buffer solution;
(5) The labeled antibody is introduced into the flow path, and incubation is conducted for five minutes;
(6) The labeled antibody is removed, and the flow path is washed with a phosphate buffer solution;
(7) A phosphate buffer solution is introduced into the flow path.

After the above step (7), the concentration of PSA protein was measured by introducing a laser beam. Thereby the concentration was confirmed to be determinable to the lower limit of 0.1 ng/mL with high sensitivity.

### Example 2

DNA hybridization was measured by use of the optical system employed in Example 1. An immunity sensor was prepared by immobilizing streptoavidin on the surface of the optical waveguide and then fixing thereon a biotin-modified 20-mer DNA probe by adsorption. With thus prepared immunity sensor, the protocol below was practiced:
(1) A specimen solution is prepared which contains a first complex constituted of a DNA to be trapped (target T1, 20-mer) having a base sequence complementary to the fixed DNA (probe) and being fluorescence-labeled with Cy5 dye, and a second complex constituted of a 20-mer DNA (target T2, 20-mer) having a base sequence different from the above by one base and being labeled with Cy3 dye;
(2) The specimen solution is introduced into the flow path, and incubation is conducted for five minutes;
(3) The specimen solution is removed, and the flow path is washed with a phosphate buffer solution;
(4) A phosphate buffer solution is filled into the flow path.

After the above step (4), laser light was introduced and the fluorescence intensity was measured. Thereby it was confirmed that the DNA (target T1, 20-mer) be determinable to the lower limit of 1 nM with high sensitivity. By examination of the spectrum of the fluorescence with a spectrometer (not shown in the drawing), it was confirmed that only the dye having a peak around 670 nm produces the fluorescence and that only the DNA of T1 specifically is bonded to the probe.

This application claims priority from Japanese Patent Application No. 2003-418173 filed Dec. 16, 2003, which is hereby incorporated by reference herein.

1. An optical analysis device comprising:
a light-transmitting member for transmitting light, having an external face capable of immobilizing a detection-objective substance;
a light separating means for separating an exciting light introduced into the light-transmitting member at a first end thereof and transmitted through the light-transmitting member, and a fluorescence light produced by excitation of the detection-objective substance by the exciting light, at a second end of the light-transmitting member, and
a detecting means for detecting the fluorescence light separated by the light separating means.

2. The optical analysis device according to claim 1, wherein the light-separating means is a diffraction grating.

3. The optical analysis device according to claim 1, wherein the light-transmitting member comprises an optical waveguide.

4. The optical analysis device according to claim 1, wherein the optical analysis device comprises a flow path which covers the light-transmitting member and has an inlet for introducing the detection-objective substance and an outlet for discharging the detection-objective substance.

5. The optical analysis device according to claim 1, wherein the light-transmitting member has at the first end thereof a coupling means for coupling the exciting light to the light-transmitting member.

6. The optical analysis device according to claim 5, wherein the coupling means is a diffraction grating.

7. The optical analysis device according to any of claims 1 to 6, wherein the external face of the light-transmitting member is capable of immobilizing a trapping component for trapping the detection-objective substance.

8. The optical analysis device according to claim 7, wherein the trapping component traps the detection-objective substance by an antigen-antibody reaction.

9. The optical analysis device according to claim 7, wherein the trapping component traps the detection-objective substance by hybridization reaction of DNA.
